(19) United States
(12) Patent Application Publication
(10) Pub. No.: US 2026/0368184 A1
(43) Pub. Date: Nov. 19, 2026

(54) LEVERAGING ARTIFICIAL INTELLIGENCE TO CREATE RELATIONSHIPS FOR AN N-DIMENSIONAL BLOCKCHAIN STRUCTURE

(71) Applicant: Providentia Worldwide, LLC, Fredericksburg, VA (US)

(72) Inventors: S. Ryan QUICK, Fredericksburg, VA (US); Armand KOLSTER, San Francisco, CA (US); Marcel VAN ECK, San Francisco, CA (US)

(73) Assignee: Providentia Worldwide, LLC, Fredericksburg, VA (US)

(21) Appl. No.: 19/207,258

(22) Filed: May 13, 2025

(51) Int. Cl. G06F 16/2457; G06F 16/22; G06F 16/28; G06F 16/901

(52) U.S. Cl. CPC G06F 16/24575; G06F 16/2264; G06F 16/288; G06F 16/9024

(57) ABSTRACT

Disclosed herein are system, method, and computer program product embodiments for implementing a modular, task-based behavior orchestration system for an N-dimensional blockchain structure. An embodiment operates by receiving a query that identifies a behavior between one or more entities. An embodiment also operates by generating a behavior configuration model comprising a task. An embodiment also operates by consulting a task catalog to obtain a reference block of machine-executable instructions. An embodiment also operates by generating a block of machine-executable instructions for the behavior. An embodiment also operates by writing the entities and the generated block onto a multi-dimensional blockchain structure. As such, the behavior orchestration system may provide more efficient and more traceable results compared to conventional systems.

### BACKGROUND

Machine learning models have many applications, such as classification and prediction, across various domains. In the software space, one class of machine learning models—large language models (“LLMs”)—have demonstrated remarkable capabilities for code generation. LLMs can understand input instructions and produce functional or near functional code. However, despite their capabilities, conventional LLMs and code generation systems face a variety of technical challenges that limit their practical deployment in real-world systems and production environments, including low reusability, poor reproducibility, limited traceability, low scalability, and others.

### BRIEF DESCRIPTION OF THE DRAWINGS

The accompanying drawings are incorporated herein and form a part of the specification.

FIG. 1 illustrates an example N-dimensional blockchain structure, according to some embodiments.

FIG. 2 illustrates a linked structure having a first blockchain linked to a second blockchain, according to some embodiments.

FIG. 3 illustrates another linked structure depicting entities, behaviors, and relationships written to blocks of an N-dimensional blockchain structure, according to some embodiments.

FIG. 4 is a diagram illustrating an exemplary N-dimensional blockchain structure and a corresponding graph.

FIG. 5 illustrates an example block diagram of a behavior orchestration system architecture, according to some embodiments.

FIG. 6 illustrates another linked structure having a first blockchain linked to second blockchains, according to some embodiments.

FIG. 7 illustrates another linked structure having a first blockchain, according to some embodiments.

FIG. 8 illustrates an example flow diagram for recording generated machine-executable instructions in an N-dimensional blockchain structure, according to some embodiments.

FIG. 9 illustrates an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Disclosed herein are system, apparatus, device, method and/or computer program product embodiments, and/or combinations and sub-combinations thereof for implementing a modular, task-based behavior orchestration system for an N-dimensional blockchain structure. As used herein, a “behavior” may refer to any sort of action that can be attributed to one or more entities, and an “entity” may refer to any object that has attributes that describe its functionality. Behaviors may be composed of one or more modular tasks that in conjunction may complete the action. The disclosed task-based behavior orchestration system may generate and manage machine-executable instructions for behaviors.

LLMs are one category of machine learning models that have emerged as useful tools for performing natural language processing (“NLP”) tasks, offering capabilities such as summarization, information retrieval, and software code generation. LLMs may provide a simple natural language interface and access to the large quantities of information on which they are trained, such as vast repositories of software code. From this training, LLMs may generate implementations for many different programming tasks across different languages and frameworks. However, despite these advancements, conventional LLM-based and/or NLP-based code generation systems suffer from a variety of technical problems that limit their practical implementation in real-world systems and production environments.

A primary technical challenge in current LLM code generation methods is the practice of repeatedly processing entire inputs and regenerating code for each development task and/or every time a requirement changes. When systems need to modify generated code or adapt it to slightly different use cases, conventional systems typically require complete regeneration of the whole solution through the LLM. This regeneration process may involve resubmitting extensive prompts that have the necessary context, constraints, and parameters, resulting in substantial computational overhead and resource utilization during inference. “Inference” as used herein may refer to the process of running data points through a trained or partially trained machine learning model to generate outputs. As development complexity increases, the inference process may become increasingly inefficient.

Conventional code generation systems also suffer from technical limitations related to reproducibility and consistency in outputs. Due to the inherently stochastic nature of LLM sampling strategies, identical prompts may yield significantly different results across multiple generation attempts. This non-deterministic behavior creates fundamental reliability issues in production environments where consistency can make or break the system. As such, systems may require many regeneration attempts with minor prompt adjustments to produce a specific final code implementation. This process results in wasted computational resources and introduces significant inefficiencies in development workflows.

Additionally, conventional code generation systems face technical problems related to context management and modular composition. LLMs typically need to operate within limited context windows that only allow a certain amount of input material that can be processed at once. As such, current systems are typically unable to load entire specifications, requirement documents, or existing codebases into a prompt; and in cases where they can include these specifications and codebases, a substantial portion of the limited context window may be taken up by potentially irrelevant pieces of context, context that could have been saved and/or used for more relevant information.

A further technical challenge faced by conventional systems is the absence of systematic version control and provenance tracking for machine-generated code. LLM-generated code typically exists as isolated artifacts without structured historical context. This technical limitation may prevent effective code auditing and code verification, which may be particularly relevant with respect to sensitive industries such as finance, healthcare, and aerospace.

Additionally, conventional code generation systems face technical inefficiencies with knowledge retention and knowledge transfer, for example across multiple inference sessions. When an LLM successfully generates a high-quality code module for a specific task, that solution's structural patterns and/or implementation details are not systematically preserved in a way that can be directly leveraged for related tasks. As such, when similar problems or use cases surface, the LLM may need to redundantly compute those structural patterns and/or implementation details, wasting computational resources that can otherwise be used to address more complex requirements. In production environments, this inefficiency may scale exponentially as the number of requirements increase. A related technical limitation faced by conventional systems is maintaining consistent interfaces between generated modules. Without mechanisms for defining and enforcing standard interface contracts, generated code modules may possess incompatible data structures, error handling patterns, and conflicting operational details. As such, additional processing may be required for refactoring and aligning generated modules into cohesive systems. When developing distributed and shared systems, these problems can result in delays affecting additional platforms, solutions, and teams otherwise independent of the code-generation effort.

Aspects of the disclosure herein solve these technological problems by implementing a modular, task-based behavior orchestration system for an N-dimensional blockchain structure. As a convenience and not a limitation, the present disclosure may be described using the terms “N-dimensional blockchain structure” and “multi-dimensional blockchain structure.” However, one of ordinary skill in the art will appreciate that the terms “N-dimensional blockchain structure,” “multi-dimensional blockchain structure,” “one or more linked blockchains,” or “one or more interlinked blockchains” may refer to any type of linked blockchain including a first blockchain linked to a second blockchain. The N-dimensional blockchain structure and actors, entities, and behaviors form one aspect of one of the foundational technologies employed by various embodiments of the present disclosure, all of which are described in further detail in U.S. patent application Ser. No. 16/812,848, now U.S. Pat. No. 11,023,458, titled “Systems and Methods for Blockchain Interlinking and Relationships,” and in U.S. patent application Ser. No. 18/533,544, titled “Governance Implementation in an N-Dimensional Blockchain,” the disclosures of which are incorporated by reference in their entireties.

The behavior orchestration system may build a task catalog by examining one or more pre-defined tasks of a pre-defined behavior recorded on a multi-dimensional blockchain structure. The behavior orchestration system may receive a query that identifies a behavior between one or more entities. The behavior orchestration system may then generate a behavior configuration model comprising a task by sending the query to a language model that references a context for a multi-dimensional blockchain structure. The behavior configuration model may be a finite automaton that defines one or more discrete tasks that work together to perform a behavior. The behavior orchestration system may then consult a task catalog using the task to obtain a reference block of machine-executable instructions corresponding to the task.

The behavior orchestration system may then generate a block of machine-executable instructions for the behavior based on the behavior configuration model and the reference block of machine-executable instructions. The behavior orchestration system may then write the one or more entities and the block of machine-executable instructions for the behavior onto a multi-dimensional blockchain structure. In some embodiments, the behavior orchestration system may write the block of machine-executable instructions for the behavior onto a linked blockchain of a multi-dimensional blockchain structure. The behavior orchestration system may also write any subsequent versions or updated versions of the block of machine-executable instructions for the behavior onto subsequent blocks appended to the linked blockchain. In some embodiments, the behavior may insert the generated block of machine-executable instructions into the task catalog alongside the task.

These approaches provide direct technological improvements over previous systems via an implementation that writes and indexes machine-executable instructions for behaviors and tasks into a multi-dimensional blockchain structure. These approaches allow for more efficient, traceable, and scalable code generation for behaviors and tasks by leveraging a task catalog containing working, verified code for tasks and append-only blockchain functionality to provide provable versioning history for generated code and code outputs. Including a behavior configuration model as context during the inference process may also curb some of the inherent randomness and variability of generative artificial intelligence systems like LLMs.

The techniques described herein also improve the functioning of a computing system. In previous implementations, an LLM or other language model would require extensive compute resources and time to tokenize and respond to code generation queries, at times queries that are largely redundant with minor changes to the input. When generating or regenerating code sections, extensive compute resources and time would be dedicated for irrelevant parts of the context (e.g., an entire code base). Furthermore, inputs from these implementations would lack the specificity and/or structure to function properly in sensitive environments.

By contrast, the embodiments described herein may first generate a behavior configuration model including one or more tasks to carry out a specified behavior. The embodiments may also leverage a task catalog with pre-defined tasks and their corresponding machine-executable instructions to obtain a relevant code block to include as context. Then, any subsequent query or re-query would only need to submit these relevant pieces of information to generate code, rather than all the information in a database, for example. This saves the computational time and resources that would otherwise have been expended during inference to formulate responses for queries with those additional, non-relevant pieces of information. Additionally, this saves memory resources that would have been required to store that additional information in memory (e.g., during inference or post-inference analysis). This also saves the computational time and resources that would have been expended to re-perform any inference or additional processing to address any requirement changes, incorrect/incomplete code, and the like. Furthermore, while the conservation of computational and memory resources may be limited with respect to a single client device, the total conservation of computational and memory resources across an entire fleet of client devices may be significant.

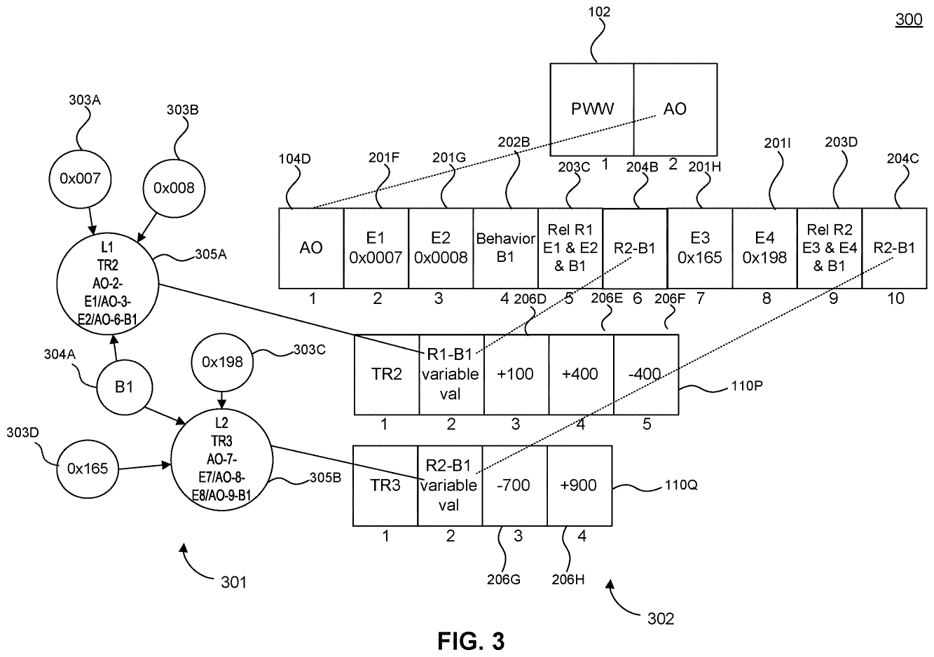

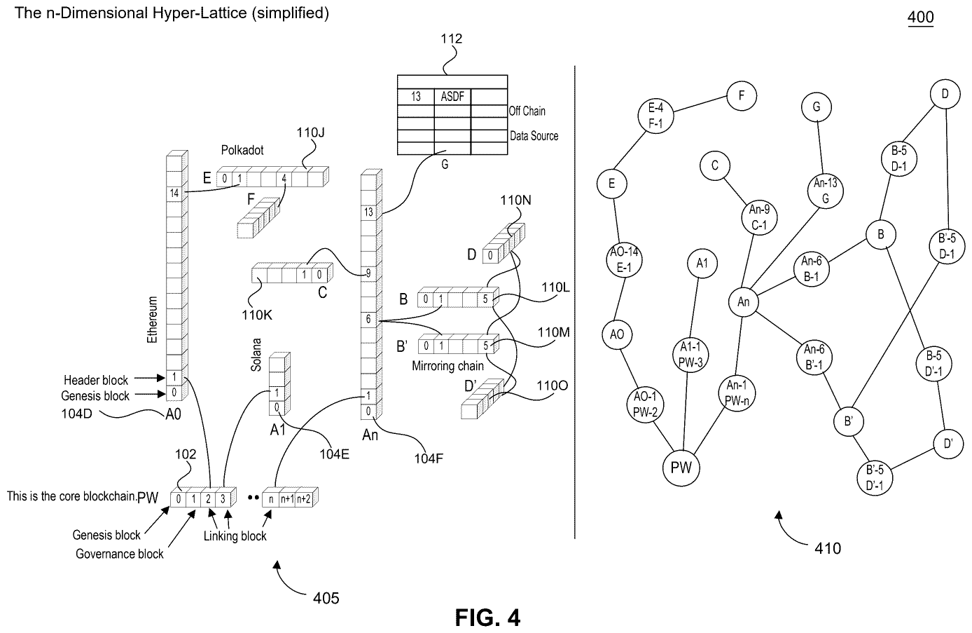

A further technical benefit may be realized by using graph technologies to capture and record the generated code for behaviors and tasks. Graph technologies support fast retrieval of information. Working in concert, graph and blockchain technologies together may provide both high performance and feature-rich relationships with the provenance and chain of custody controls required for guaranteed ordering. This fusion of blockchain and graph technology significantly reduces transaction times and significantly increases search speeds. Graph technology allows multi-dimensional relationships to be retrieved without linear blockchain traversal—e.g., a single graph query can retrieve all relationships in the N-dimensional blockchain structure to which a particular entity belongs, what behaviors have been transacted against, etc. without requiring linear blockchain traversal, which is inherently slow. Graph technology also allows retrieval of data relationships that other storage mechanisms or databases cannot support. For example, a graph may support: (1) a search for the entities involved with particular behaviors, (2) a query on the ‘proximity’ of one actor to another, (3) a query on the ‘size’ of the network in which an entity is involved in, or (4) a query for one or more relevant code blocks for a given task. Graph technology may also support the routing of transactions, tasks, and/or writes to a particular block, blockchain, or off-chain location based on a behavior allowing the transaction to be written to that location. Graph technology may also support routing in other use cases and contexts. A wide-array of additional functions, behaviors, and uses of graph technologies in tandem with the N-dimensional blockchain structure are performable, as would be understood by a person of ordinary skill in the art. The use of graph technologies in concert with the N-dimensional blockchain structure is discussed in further detail below with reference to FIGS. 3-4.

These technical advantages may be appreciated, for example, in resource-constrained environments and large-scale software deployment and orchestration systems.

The overall computational efficiency of these systems may be improved as a result and the conserved resources may be reallocated for other tasks. The verifiable and provable nature of the task code blocks written to the multi-dimensional blockchain may also lead to fewer computational errors and higher performance accuracy.

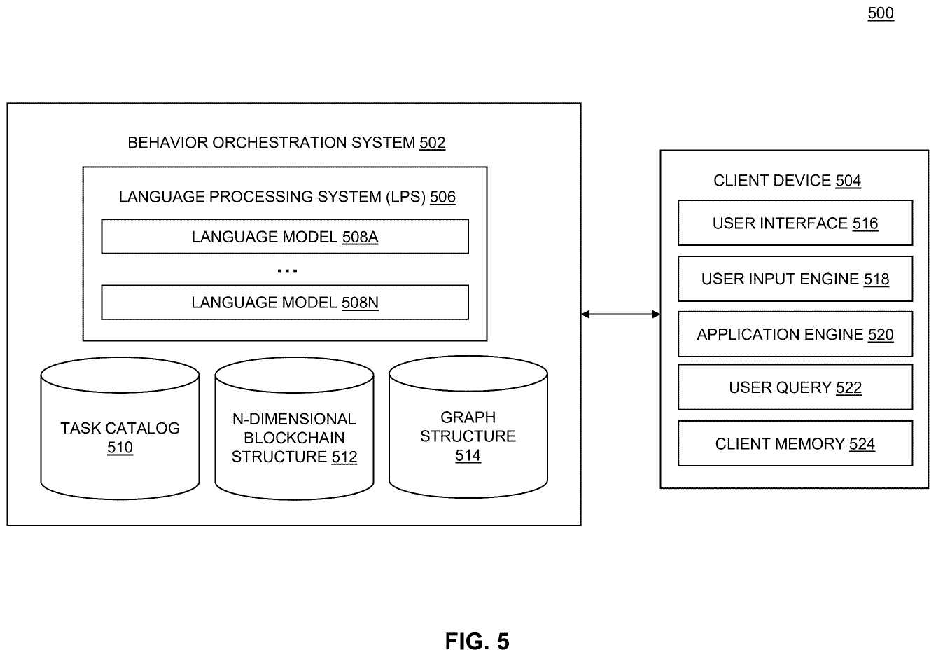

Various embodiments of this disclosure may be implemented using and/or may be a part of the example behavior orchestration system shown in FIG. 5. It is noted, however, that these environments are provided solely for illustrative purposes, and are not limiting. Embodiments of this disclosure may be implemented using and/or may be part of environments different from and/or in addition to the example behavior orchestration system, as will be appreciated by persons skilled in the relevant art(s) based on the teachings contained herein.

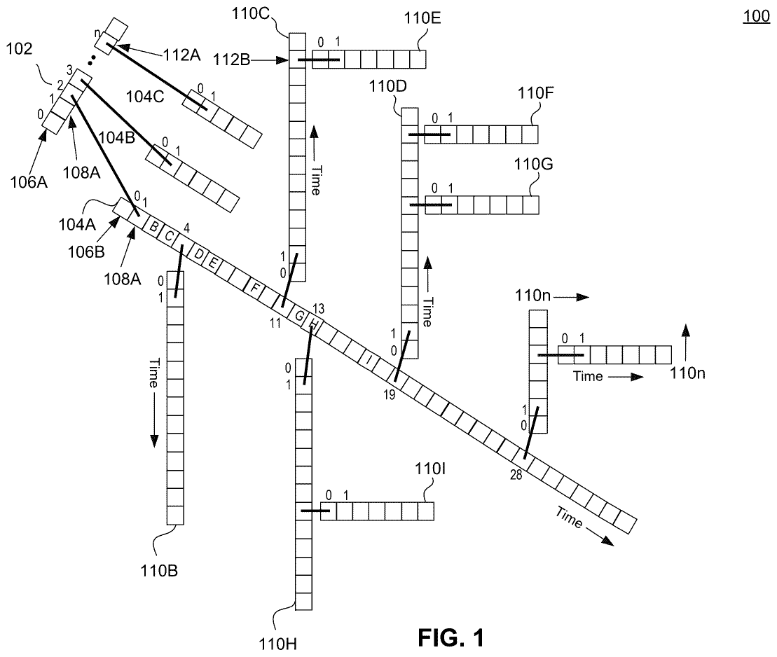

FIG. 1 illustrates an example N-dimensional blockchain structure, i.e., structure 100, according to some embodiments. The specific composition of structure 100 provided in FIG. 1 is merely exemplary.

It is important to note that for ease of explanation, this disclosure refers to blockchains 104A-104C and 110B-110n, respectively, as “first blockchains” and “second blockchains.” However, alternative terminology may apply. For example, first blockchains 104A-104C may be referred to as antecedent blockchains, core blockchains, parent blockchains, governing blockchains, etc. Similarly, second blockchains 110B-110n may be referred to as descendent blockchains, sub-blockchains, child blockchains, governed blockchains, etc. Familiar relationships may describe relationships between different chains, e.g., second blockchain 110B and second blockchain 110H may be referred to as sibling blockchains, second blockchain 110I and second blockchain 110E may be referred to as cousins, etc. Other suitable terminology may apply to adequately convey the role and relationships of the various chains in distributing governance information across structure 100.

Additionally, this “first” and “second” nomenclature does not imply that a hierarchical nature exists within structure 100. While the chain at 110H may be referred to as second blockchain 110H, second blockchain 110H may doubly serve as the “first blockchain” with respect to second blockchain 110I. In this regard, as the N-dimensional blockchain structure expands, structure 100 may include blockchains that serve both as a “first blockchain” and a “second blockchain.”

As illustrated in FIG. 1, structure 100 may include core blockchain 102, first blockchains 104A-104C, genesis blocks 106A-106B, header block 108A, and second blockchains 110B-110n.

Core blockchain 102 may include a genesis block (genesis block 106A) and blocks (in FIG. 1, numbered 0, 1, 2, 3 . . . n) linked to first blockchains 104A-104C. Core blockchain 102 may store logic that specifies conditions under which to create an additional linked blockchain. This ability to dynamically create new chains improves the atomic reliability and overall transactional availability of structure 100 because maintaining shorter blockchains provides a means to move new operations away from larger blockchains as operational requirements demand. In some embodiments, this logic may take the form of a smart contract or other suitable computer program. For example, the logic may specify that core blockchain 102 should create an additional blockchain each day at noon. In such an example, day after day, core blockchain 102 would add an addition blockchain at noon. In an embodiment, this logic may be sharding logic that implements a series of shards by providing programmable rules that define sharding criteria. In such a sharding scheme, horizontal partitioning of data may be achieved by deriving a shard key from the data of interest using algorithms including modulus, consistent hashing, or text mapping.

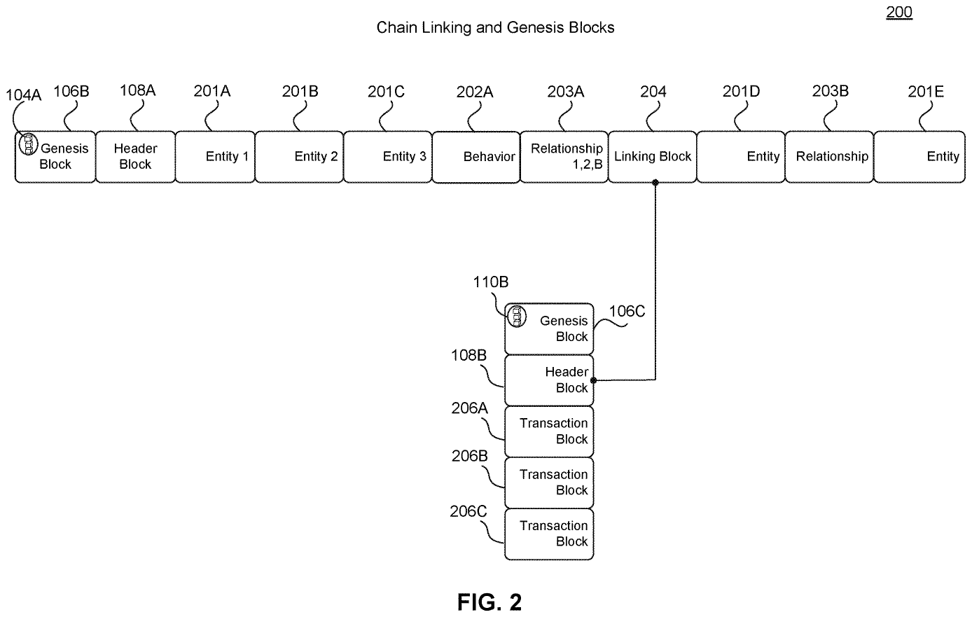

First blockchains, such as first blockchains 104A-104C, may include genesis blocks (e.g., genesis block 106B) and header blocks (e.g., header block 108B). While FIG. 1 illustrates three blockchains as first blockchains 104A-104C, this is merely exemplary, and core blockchain 102 may create any number (even hundreds, thousands, millions, etc.) of first blockchains 104-104C to facilitate the extensibility of the N-dimensional blockchain structure. First blockchains 104A-104C may record information about entities, behaviors, and relationships, and blockchain links. This information may cumulatively be referred to as “governance information.” In one embodiment, governance information may be included in a single block in a first blockchain. However, in other implementations, governance information may be separated into distinct block types. The governance information of a second blockchain may include provenance and end-to-end, behavior-transaction traversal, but may not impede or influence the transactional nature or functionality of a governed second blockchain after the initial creation of the second blockchain. The nature of governance information and further details on entities, behaviors, and relationships are discussed in further detail below with reference to FIG. 2.

Genesis blocks, such as genesis block 106A and genesis block 106B, may be the initial block on a blockchain. For example, in FIG. 1, the block labeled “0” is genesis block 106A of first blockchain 104A.

Header blocks, such as header block 108A may hold metadata about the blockchain itself, which may include, but is not limited to, a reference to the linking block on core blockchain 102 or to a first blockchain, sharding implementation, currency or trading token, block type, value token, transactional cost, transactional hints, source and destination data types, source and destination repository types, etc. In some embodiments, a header block is the block immediately following a genesis block, such as genesis block 106B. For example, in FIG. 1, the block labeled “1” in first blockchain 104A is header block 108A of first blockchain 104A. The block labeled “1” in second blockchain 110B is the header block of second blockchain 110B.

Second blockchains, such as second blockchains 110B-110n, may record transactions as results of the one or more tasks needed to perform a behavior for a relationship between entities. The results of a task may include inputs, outputs, decisions, variables, and any other component required to complete the task. For example, results of a task may include one or more results from executing machine-executable instructions corresponding to an associated task and/or behavior, as well as results of relationships composed of a behavior and one or more entities. Second blockchains 104A-C may also include genesis blocks and header blocks. Second blockchains 110B-110n may simultaneously serve as “first blockchains” by also recording information about entities, behaviors, and relationships, and links to second blockchains. For example, blockchain 110C is both a “second blockchain” with respect to blockchain 104A and a “first blockchain” with respect to blockchain 110E.

In structure 100, links are illustrated by the lines connecting the individual blockchains. For example, FIG. 1 illustrates a link between core blockchain 102 and first blockchain 104A and links between first blockchain 104A and second blockchain 110B and second blockchain 110H. In some embodiments, on a first blockchain, a linking block is the block that contains reference information to jump to a second blockchain. In one embodiment, this linking block may include metadata that specifies a new genesis block, a blockchain identifier, a sharding implementation, and owning entity for the second blockchain. A genesis block identifier may also be recorded as part of the metadata in the linking block on a first blockchain. FIG. 1 also illustrates linking blocks. For example, block “2” of core blockchain 102 is a linking block, which is linked to header block (block “1”) of first blockchain 104A. Block “4” of first blockchain 104A is a linking block, which is linked to the header block (block “1”) of second blockchain 110B.

In some embodiments, first blockchains 104A-104C and second blockchains 110B-110n may leverage a single value or utility token determined at creation. A value and a utility token are the same or similar. In other embodiments, a value token may be different than a utility token. A utility token may provide only the necessary fuel or power behind a behavior which is recorded in a blockchain, whereas a value token may provide for power behind a behavior and may acquire quantitative value in its own right, making the value token itself a desirable asset. In some embodiments, accruing value tokens may provide conditions for unlocking utility tokens. As one non-limiting example, an entity may accrue value tokens for every hour of community service performed, and by performing a hundred hours of community service, the entity can now access one or more utility tokens (e.g., the ability to participate in an upcoming fundraising event, etc.). Alternatively or additionally, the value token may be an “undesirable asset” and used for punishments. As one non-limiting example, if an entity attempts to gain an unfair advantage (e.g., undoing fairness in a shared work pattern), that entity may accrue value tokens in a negative context, such as accruing points on a driver's license or demerits at school. First blockchains 104A-104C and second blockchains 110B-110n may be created with a specific value token determined through referential query of the blockchain type. In some embodiments, the value token identifier is included in the blockchain identifier.

FIG. 2 illustrates linked structure 200 having a first blockchain linked to a second blockchain, according to some embodiments. Specifically, FIG. 2 refers to first blockchain 104A and second blockchain 110B from FIG. 1. However, the use of these chains in particular is merely for ease of illustration, and the characteristics of the chains and governance information discussed below applies to first blockchains and second blockchains, generally. In both FIG. 1 and FIG. 2, first blockchain 104A governs second blockchain 110B, and second blockchain 110B is subordinate to first blockchain 104A.

In FIG. 2, first blockchain 104A includes genesis block 106B, header block 108A, entity 201A, entity 201B, entity 201C, behavior 202, relationship 203A, linking block 204, entity 201D, relationship 203B, and entity 201E. Second blockchain 110B includes genesis block 106C, header block 108B, and transaction blocks 206A-206C.

Entities 201A-201C may be written to first blockchain 104A. An entity may be an actor in an ecosystem—e.g., an entity may represent a human actor, account, object, wallet, token, group, combinations of outputs from behaviors, a process, a computer an artificial intelligence construct, an avatar representing an actor or action, an expression or function comprising actions, or any concept of potentially taking action in a behavior. As another non-limiting example, an entity may represent a code generation module that generates machine-executable instructions for behaviors involving one or more entities. Information associated with the entities may include entity attributes that describe the entity including: entity type, entity token, entity creation timestamp, entity creation endpoint, entity creation transaction, observational records, etc. This disclosure refers to entities such as human actors, account actors, or token actors as “actor entities.” This disclosure refers to combinations of entities, behaviors, and relationships as “relationship entities.”

Behavior 202A may be written to first blockchain 104A. A behavior may represent the building blocks or tasks for constructing bounded automata. A behavior may describe the mechanism by which entities interact, transact, or act upon each other, providing the context for governing and transacting between entities. Collectively, behaviors may provide a rich catalog for creating complex operations and a means by which those operations may be valued and immutably stored. A behavior may be composed of one or more tasks that must be completed to achieve the desired result. In one embodiment, an enforcement mechanism may be written in behavior 201. The enforcement mechanism may be a smart contract, append-only structure, blockchain transaction, journaling protocol, or other form of code that performs the tasks while providing immutability and transparency in method and operation. In some embodiments, a behavior may have a corresponding behavior configuration model, which may provide implementation details, configuration information, and/or blockchain addresses for the one or more tasks that make up the behavior. For example, a behavior configuration model may be a finite automaton that concretely defines the one or more discrete tasks that work together to perform a behavior. Alternatively or additionally, a behavior configuration model may also be an interactive and/or reactive automaton.

Relationship 203A may be a codified link between at least one entity and at least one behavior. While typically multiple entities transact, certain relationships may involve a single entity performing a behavior. Generally, a relationship's characteristics are captured as attributes. Relationships may be abstracted as additional inputs to form other relationships with additional behaviors and entities. In this regard, chained relationships may be used as building blocks for more complex behaviors.

An example of entities, behaviors, and relationships shall now be described. An actor “E1” may wish to send an actor “E2” an asset “E3.” Actor “E1” may have a corresponding entity, entity “A”, and a corresponding asset, asset “A1.” Actor “E2” may have a corresponding entity, entity “B”, and a corresponding asset, asset “A2.” The behavior (e.g., sending an asset) may be composed of three tasks: (1) a “link” task that sends messages to a first chain with entity “A” and a second chain with entity “B” to ensure that their assets (asset “A1” and asset “A2”) exist before a transfer can be made; (2) a “decrement” task that decrements a value of an asset owned by the giving entity (e.g., asset “A1”); and (3) an “increment” task that increments a value of an asset owned by the receiving entity (e.g., asset “A2”). The end result of this immutable behavior, related entity, and assets inputs moves an asset on the first chain to the second chain. In some embodiments, a behavior may refer to the one or more tasks more generally (e.g., sending an asset), and a relationship may refer to a behavior that involves specific entities (e.g., sending an asset from entity “A” to entity “B”) In an embodiment, a relationship may be immutably written to the linking block of the first blockchain and the header block on a second blockchain as an enforcement mechanism. A graph database may also be updated accordingly to reflect a relationship that has been written to the multi-dimensional blockchain structure.

For future transactions, the platform may merely write the results of the tasks into the appropriate second blockchain. Thus, every transaction conducted between “E1” and “E2” to transfer “E3” may be recorded in the second blockchain with minimal overhead. This transaction need not be limited to a particular amount of E3. A behavior may be crafted that allows any asset value to be transacted between any entities (e.g., 100, 500, 1000, etc.) that may be reused by multiple entities. Conversely, a behavior may be created that only allows a specific value to be transacted and between particular entities, e.g., only 10000 E3 and only between E1 and E2. Any interaction may be represented provided an appropriate function (i.e., the tasks) is created that results in the correct output. A new relationship may be created for transactions conducted between other entities, but the behavior of “sending an asset” may be reused in other relationships. Other relationships may include different entities, assets, and behaviors. Other relationships could conduct transactions on different second blockchains. In one embodiment, an enforcement mechanism may be understood as a network that encompasses the entities, behaviors, and relationships. In this example, the network may be labeled “Z-network” and may include all components needed to move asset E3 from E1 to E2using the behavior (e.g., behavior B1). This Z-network may be called like a function, e.g., Z1(E1, E2, A1, A2, B1, B2). The Z-network may also mimic a network in the graph.

Several additional examples illustrate such relationships. As an example, the notion of submitting information may be abstracted—an actor of “Freelance Journalist” may send a news story to an actor of “Newspaper Editing Desk” for printing. The relationship may be called “submitStory” and the relationship may have characteristics including language, length, topic, payment_rate_per_word, acceptance_criteria, byline, etc. In this example, general behavior between Journalist and Newspaper may include a transfer of information with certain attributes (a first task) and positive or negative acknowledgment of that transfer (a second task). This in turn allows for a patterned method of implementing the data transfer, the acceptance of the transfer, how to handle state changes in the automata, creation of discrete time intervals for the activity, and a means by which value may be attached to the abstract machine. In another example, an actor of “Artist” might mint a non-fungible token (“NFT”) for an actor of “Marketplace.” The relationship may be called “mintNFT” and may have characteristics including medium, media_type, color_map, signature, title, collection_id, collection_number, etc.

As with any of the examples described above, tasks may be associated with corresponding code blocks or blocks of machine-executable instructions. In some embodiments, these task and code pairings may be stored within a task catalog, along with any other descriptive metadata, inside a data store, the multi-dimensional blockchain structure, and/or a graph database corresponding to a multi-dimensional blockchain structure.

As depicted in FIG. 2, linking block 204 may link first blockchain 104A to header block 108B of second blockchain 110B. In some embodiments, linking block 204 and/or header block 205 may contain governance information including the behavior, relationship, and structure of the two related blockchains. Linking block 204 and/or header block 108B may also include an enforcement mechanism to perform the tasks comprising behavior 202A. The enforcement mechanism may be immutable, static, and un-modifiable. The enforcement mechanism may receive one or more inputs and perform the enforcement mechanism using the inputs as parameters. The enforcement mechanism may be a smart contract, append-only structure, blockchain transaction, journaling protocol, or other form of code that performs the tasks while providing immutability and transparency in method and operation. In embodiments using strong enforcement, the enforcement mechanism may be included in a block or blocks that follow the linking blocks of the second blockchain to set the behavior/task structure for the chain.

Second blockchain 110B may capture transactional data for a relationship created on first blockchain 104A having at least one behavior and at least one entity. In second blockchain 110B, header block 108B immediately follows genesis block 106C. Second blockchain 110B may function independently from a governing first blockchain (here, first blockchain 104A) for behavior and performance. Transaction blocks 206A-206C may record transactions conducted under the stored relationship (here, relationship 203A). Because the enforcement mechanism for conducting the relationship is immutably written in the blockchain structure, a transaction may be recorded as the results of the tasks of behavior 202A. The results of a task may include inputs, outputs, decisions, variables, and any other component required to complete the task. For example, results of a task may include one or more results from executing machine-executable instructions corresponding to an associated task and/or behavior, as well as results of relationships composed of a behavior and one or more entities. Given the permanent and tamperproof governance information in the first blockchain, the functional results suffices to ascertain retroactively and with certainty the details of the transaction.

FIG. 3 illustrates linked structure 300 depicting entities, behaviors, and relationships written to blocks of an N-dimensional blockchain structure, according to some embodiments. Specifically, linked structure 300 includes linked structure 302 having core blockchain 102, first blockchain 104D, second blockchain 110, and second blockchain 110Q. However, the use of these chains in particular is merely for ease of illustration, and the characteristics of the chains and governance information discussed below applies to first blockchains and second blockchains, generally. In FIG. 3, first blockchain 104D governs second blockchain 110P and second blockchain 110Q.

In FIG. 3, relationship 202C includes behavior 202B between entity 202F and entity 202G. Relationship 202D includes behavior 202B between entity 202H and entity 202I. Each relationship is reflected with separate linking blocks, linking block 204B and linking block 204C, to second blockchain 110P and second blockchain 110Q, respectively.

These second blockchains then record the transactions (transactions 206D-206H) conducted under the relationship.

Graph technologies may work in concert with the blockchains in the N-dimensional blockchain structure to significantly reduce transaction times and significantly increase search speeds. As discussed above, the disclosed platform recognizes an improvement by treating the specific combination of entities and behaviors (made up of tasks) as an immutable construct. This relationship construct may be written into linking blocks and header blocks on the N-dimensional blockchain structure and reflected in the graph.

In FIG. 3, linked structure 300 may also include graph representation 301. Graph representation 301 may include nodes and links (edges) recorded using a graph database or other suitable graph technology. Graph representation 301 may include entity nodes 303A-303D, behavior node 304A, and location nodes 305A-305B. In FIG. 3, entity nodes 303A-303D correspond to entities 202F-202I, location nodes 305A-305B correspond to header blocks of the second blockchains, and behavior node 304A corresponds to behavior 204B. The links between these nodes represents a relationship and may be recorded in a graph database as edges between two nodes.

Applying a suitable graph technology, multi-dimensional relationships may be retrieved without linear blockchain traversal. For example, a single graph query may retrieve all relationships in the N-dimensional blockchain structure to which an entity belongs. This can be completed without traversing the blockchains. For example, a graph query could be formulated to retrieve all transaction locations in the N-dimensional blockchain structure in which a specific entity node was a participant. By examining the links between that entity and associated locations and behaviors, linear traversal of a blockchain structure is unnecessary.

FIG. 4 illustrates an environment 400 having another exemplary N-dimensional blockchain structure, structure 405, and corresponding graph 410. As discussed above, structure 405 relies on static, immutable governance that is associated with each individual chain and that represents the entities, behaviors, and relationships. Transactions on the chain constitute the behavior and cannot be altered once created. This means that while these transactions are recorded on-chain, alterations to the methodology of that chain are not permitted. This approach where governance is immutably written into the blockchain structure differs from more conventional approaches to blockchain implementations that lack an on-chain ground truth for the behaviors and relationships, and validation and confirmation of transactions instead leverage relative values of the transaction with regards to a common blockchain.

Structure 405 includes core blockchain 102, first blockchains 104D-104F, and second blockchains 110J-110O. Structure 405 also includes off-chain data source 112. Off-chain data source 112 may include databases, files, key-value stores, programmatic outputs, constants, memory addresses and regions, hardware devices, key stores, cryptographic wallets, and other suitable data sources outside of a blockchain structure. In some embodiments, off-chain data source 112 may include a task catalog with task and code pairings that may be leveraged in a behavior orchestration pipeline. Structure 405 may also include data sources by writing appropriate governance information to first blockchain 104F. In an embodiment, governance information to support off-chain data sources may include an enforcement mechanism crafted to access a particular type of data source. Similarly, constructs such as append-only tables, ledgers, hash maps, and the like can provide behaviors similar to blockchains as described above, but in alternate contexts and mediums. This allows the reach of the system to extend into alternate implementations while retaining the benefits, provenance, and in some embodiments the immutability of the blockchain solution described herein.

Graph 410 includes a representation of the behaviors, locations, and entities included in all core and all first and second blockchains in structure 405. Each unique entity, location, and behavior is recorded as a node in graph 410. All relationships between blockchains, entities, behaviors, and locations are represented as links (edges) in graph 410.

FIG. 5 illustrates an example block diagram of a behavior orchestration system architecture 500, according to some embodiments. Operations described may be implemented by processing logic that may comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 5, as will be understood by a person of ordinary skill in the art.

Behavior orchestration system architecture 500 may include a behavior orchestration system 502 and a client device 504. In some embodiments, example behavior orchestration system architecture 500 may be implemented partially or entirely on client device 504. In some embodiments, example behavior orchestration system architecture 500 may be implemented partially or entirely at third party servers or within the cloud. In such embodiments, behavior orchestration system 502 and client device 504 may be communicatively coupled with each other via one or more networks such as an ad hoc network, an intranet, an extranet, a virtual private network (VPN), a local area network (LAN), a wireless LAN (including Wi-Fi, mesh networks, Bluetooth, near-field communication, etc.), a wide area network (WAN), a wireless wide area network (WWAN), a metropolitan area network (MAN), a portion of the Internet, a portion of the Public Switched Telephone Network (PSTN), a cellular telephone network, a wireless network, a WiMax network, any other type of network, or a combination of two or more such networks.

In some embodiments, behavior orchestration system 502 may include a language processing system (LPS) 506, a task catalog 510, an n-dimensional blockchain structure 512, and a graph structure 514. Behavior orchestration system 502 may be implemented as one or more servers and/or one or more cloud servers. Behavior orchestration system 502 may also be implemented as a variety of centralized or decentralized computing devices. For example, behavior orchestration system 502 may operate on a mobile device, a laptop computer, a desktop computer, grid-computing resources, a virtualized computing resource, cloud computing resources, peer-to-peer distributed computing devices, a server farm, or a combination thereof. Behavior orchestration system 502 may be centralized in a single device, distributed across multiple devices within a cloud network, distributed across different geographic locations, or embedded within a network.

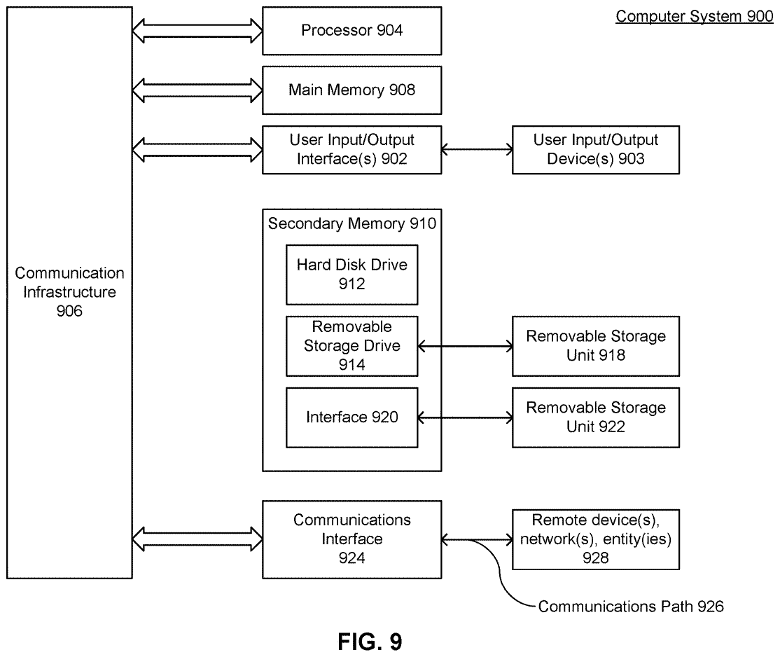

In some embodiments, behavior orchestration system 502 may include one or more data stores that store various data used by behavior orchestration system 502. For example, behavior orchestration system 502 may include a task catalog 510, an n-dimensional blockchain structure 512, and a graph structure 514. N-dimensional blockchain structure 512 may be an example of and/or similar to structure 100 (of FIG. 1) structure 200 (of FIG. 2), structure 300 (of FIG. 3) or structure 405 (of FIG. 4). Graph structure 514 may be an example of and/or similar to graph representation 301 (of FIG. 3) or graph 410 (of FIG. 4). Any of task catalog 510, n-dimensional blockchain structure 512, and graph structure 514 may be stored, for example, in a volatile memory (e.g., random access memory (RAM)), a non-volatile storage device (e.g., a disk), or in a distributed and/or redundant manner across multiple memories and/or storage devices. In some embodiments, task catalog 510, n-dimensional blockchain structure 512, and/or graph structure 514 may be managed by and accessed via a corresponding database management system (DBMS), which is not shown in FIG. 5 for the sake of simplicity. Task catalog 510, n-dimensional blockchain structure 512, graph structure 514, and any corresponding DBMS may be implemented on one or more computer systems, such as computer system 900 as described below in reference to FIG. 9. Task catalog 510, n-dimensional blockchain structure 512, graph structure 514, and any corresponding DBMS may also be implemented on one or more servers of an enterprise network and/or a cloud computing network.

In some embodiments, behavior orchestration system 502 may generate and manage machine-executable instructions for behaviors between entities. In some embodiments, behavior orchestration system 502 may receive queries from client device 504, interact with LPS 506 to generate behavior configuration models, consult task catalog 510 for reference code blocks, generate new code blocks for behaviors, and write entities and code blocks to n-dimensional blockchain structure 512. In some embodiments, behavior orchestration system 502 may be implemented as a set of computer-executable instructions stored on one or more non-transitory computer-readable media and executed by one or more processors. In some embodiments, behavior orchestration system 502 may include a caching mechanism to store frequently used behavior configuration models and code blocks. This caching system may reduce processing time for common queries by avoiding the need to regenerate models or consult the task catalog for every request.

Client device 504 may be one or more of a desktop computer, a laptop computer, a tablet, a mobile phone, a smart appliance such as a smart television, and/or a wearable apparatus of the user that includes a computing device (e.g., a smartwatch, smart glasses, or a virtual or augmented reality computing device). Additional and/or alternative client devices are within the scope of this disclosure. Client device 504 may include a corresponding user interface 516, user input engine 518, application engine 520, user query 522, and client memory 524.

User interface 516 may be configured to render content including unimodal responses, multimodal responses, or other content for audible or visual presentation to a user of client device 504 using one or more user interface output devices. For example, client device 504 may include a display or projector that enables content to be provided for visual presentation to a user via client device 504. Alternatively or additionally, client device 504 may include one or more speakers that enable content to be provided for audible presentation to a user via client device 504.

User input engine 518 may detect user input provided by a user of client device 504 using one or more user interface input devices. For example, client device 504 may include one or more microphones that capture audio data, such as audio data corresponding to spoken utterances of the user or other sounds in an environment surrounding client device 504. Alternatively or additionally, client device 504 may include one or more vision components (e.g., a camera) that may capture vision data corresponding to images and/or movements (e.g., gestures) detected in a field of view of one or more of the vision components. Alternatively or additionally, client device 504 may include one or more touch sensitive components including, but not limited to, a keyboard and mouse, a stylus, a touch screen, a touch panel, and physical buttons configured to capture signals corresponding to touch input directed towards client device 504.

Application engine 520 may execute one or more software applications on client device 504. In some embodiments, application engine 520 may submit a natural language query (e.g., user query 522) to behavior orchestration system 502. Application engine 520 may then receive unimodal, multimodal, or other responses from behavior orchestration system 502 in response to a natural language query, which may then be rendered onto user interface 516 (e.g., audibly and/or visually). Application engine 520 may execute one or more software applications that are separate from an operating system of the client device 504 or may alternatively be implemented directly by the operating system of client device 504. For example, the application engine 520 may execute one or more software applications via a web browser or assistant.

User query 522 may represent an input provided by a user of client device 504 and may be detected via user input engine 518. For example, user query 522 may include a question or task by a user or system regarding an interaction or behavior between one or more entities. In some embodiments, user query 522 may be a typed query that is entered via a physical or virtual keyboard, a suggested query that is selected via a touch screen or a mouse of client device 504, a spoken voice query that is detected via a microphone of client device 504 (or directed to a voice assistant running at client device 504), or an image or video query that is based on vision data captured by a vision component of client device 504.

In some embodiments, user query 522 may be converted from or to a natural language based input or a multimodal input to be submitted to behavior orchestration system 502. Alternatively or in addition, user query 522 may be sourced via image processing techniques utilizing, for example, object detection models, captioning models, recognition models, or the like. In some embodiments, user query 522 may be a prompt for content that is formulated based on user input provided by a user of client device 504 and detected via user input engine 518. For example, the prompt can be a typed prompt that is entered via a physical or virtual keyboard, a suggested prompt that is selected via a touch screen or a mouse of client device 504, a spoken prompt that is detected via a microphone of client device 504, or an image or video prompt based on data captured by a vision component of client device 504.

Client memory 524 may include a data store containing data about a user of client device 504 or about client device 504 itself. In some embodiments, client memory 524 may store one or more queries (e.g., user query 522) made by a user of client device 504. Client memory 524 may also store a context of client device 504. As just one example, client memory 524 may store conversation data by a user or system with behavior orchestration system 502. Client memory 524 may also store user or system interaction data about current or recent interactions between a user, a system, multiple users, or multiple systems and client device 504. In some embodiments, client memory 524 may also store location data about current or recent locations of client device 504 or a geographical region associated with a user of client device 504. Client memory 524 may also store user attribute data, user preference data, a user profile, or various configurations relating to client device 504 or a user of client device 504. In some embodiments, the data stored in client memory 524 may be communicated partially or entirely to behavior orchestration system 502 (e.g., to produce higher quality outputs and/or provide results more efficiently).

In some embodiments, client device 504 may include a local task cache. This cache could potentially store frequently used tasks and their corresponding code blocks locally on the client device, potentially reducing network traffic and improving response times for common queries. The local cache may be synchronized periodically with the main task catalog 510 to ensure it remains up-to-date. The cache may utilize a variety of validation and invalidation techniques to assure accuracy and coherency with the primary records in the main task catalog 510.

Language processing system (LPS) 506 may be a distributed computing system configured to execute one or more machine learning models, such as language models 508A-508N (collectively, “language models 508”). In some embodiments, language models 508 may be unimodal and/or multimodal transformer and/or neural network based language models trained on large amounts of unimodal and/or multimodal data (e.g., LLMs). Language models 508 may employ various model architectures including, but not limited to, encoder-decoder, causal decoder, and prefix decoder architectures. Language models 508 may also leverage reasoning model architectures and/or reinforcement learning. Language models 508 may be machine learning models trained to process and generate natural language text. Language models 508 may also be neural network or expert systems designed to process and generate natural language text, produce learning outcomes, and/or solution explanations and outcomes. Language models 508 may take queries or prompts as input and generate relevant textual outputs. Language models 508 may also analyze queries, extract relevant details about entities and intended behaviors, and generate structured behavior configuration models that define discrete tasks needed to accomplish those behaviors. In some embodiments, LPS 506 may be fully integrated within behavior orchestration system 502. In such embodiments, language models 508 may be locally deployed machine learning models, offering increased security, reduced latency, and customized processing pipelines tailored towards the specific requirements of behavior orchestration system 502.

Various components of behavior orchestration system 502 may communicate directly with LPS 506 and language models 508 to perform various tasks, such as generate behavior configuration models, generating and/or obtaining reference code blocks for one or more given input tasks, generating new code blocks for behaviors and more. In some embodiments, LPS 506 may reference context related to the multi-dimensional blockchain structure 512 when generating behavior configuration models, including one or more libraries of pre-defined behaviors, relationships, behavior configuration models, tasks, code blocks, and the like. In some embodiments, behavior orchestration system 502 may include an LPS interface (not shown) to facilitate communications between various components of behavior orchestration system 502 and LPS 506. Alternatively or additionally, LPS 506 may exist as a separate system from behavior orchestration system 502. In such embodiments, LPS 506 may leverage third-party, enterprise, or cloud-based services that host and maintain language models 508. Similarly, various components of behavior orchestration system 502 may communicate with LPS 506 directly (e.g., via public API calls, a virtual private cloud connection, messaging middleware, etc.) or via an LPS interface.

In some embodiments, behavior orchestration system 502 may interact with LPS 506 via queries, such as prompts. A prompt may refer to unimodal or multimodal natural language instructions or computer code that is fed into a language processing system (e.g., LPS 506). A prompt may include contexts, user instructions, system instructions, formatting requirements, and/or other metadata for guiding LPS 506 towards generating a desired output. Prompts may come in many different forms and have various different applications. As a few non-limiting examples, prompts may define functionality for generating behavior configuration models or blocks of machine-executable instructions for tasks. In some examples, prompts may also include images, audio, or even video inputs. This could allow for more diverse and rich queries, potentially enabling users or systems to describe behaviors or entity interactions using various media types. In some embodiments, LPS 506 may implement a model selection algorithm that can dynamically choose the most appropriate language model from language models 508 based on the nature of a query and/or a specific behavior being requested (e.g., lightweight models for smaller queries and/or smarter models for longer or more complex queries). This may involve techniques such as meta-learning or automated machine learning (AutoML) to optimize model selection.

In constructing prompts, behavior orchestration system 502 may leverage one or more prompt templates, according to some embodiments. Prompt templates may define certain structures for prompts to follow before they are submitted to LPS 506. Prompt templates may leverage predefined configurations or optimizations for obtaining more accurate and higher quality responses by LPS 506. For example, prompt templates may provide additional context for a task and specific rules or guidelines to follow during inference. “Inference” as used herein may refer to the process of running data points through a trained or partially trained machine learning model to generate outputs. Prompt templates may also define how any user queries, specific pieces of content, or additional information received via one or more vetting processes are incorporated into prompts for LPS 506. In some embodiments, one or more entities, behaviors, properties, relationships, behavior configuration models, tasks, blocks of machine-executable instructions (e.g., “code blocks”) from task catalog 510, n-dimensional blockchain structure 512, or graph structure 514 may be incorporated into a prompt template to be transmitted to LPS 506. As one non-limiting example, a prompt template may include various placeholders where a behavior configuration model and a reference block of machine-executable instructions for a task is inserted. After constructing a prompt, behavior orchestration system 502 may query LPS 106 with the prompt to generate a response.

In constructing a response, LPS 506 may employ various techniques including, but not limited to multi-head self-attention mechanisms, positional encoding, layer normalization, masked autoregressive decoding nucleus sampling, softmax token distribution computation, and key-value cache optimization. In some embodiments, LPS 506 may also incorporate a query optimization module. This module could potentially analyze incoming queries and rewrite them in a form that is optimized for the language models, potentially improving the accuracy and efficiency of behavior configuration model generation. The optimization may involve techniques including but not limited to query expansion, entity recognition/matching, or context-aware rephrasing.

Task catalog 510 may store pre-defined tasks and corresponding blocks of machine-executable instructions for behaviors that can be performed, recorded, and/or explained in the N-dimensional blockchain structure 512. Task catalog 510 may serve as a repository of reusable code components that may be leveraged to efficiently generate new behavior implementations. In some embodiments, task catalog 510 may be constructed by examining pre-defined tasks of pre-defined behaviors already recorded on the N-dimensional blockchain structure 512. For each task, it may store metadata about the task along with the actual block of machine-executable instructions. For example, task catalog 510 may store a task complexity, an average task execution time, or resource requirement for a task. This information can be used to optimize the overall behavior implementation or to provide estimates of the behavior's performance characteristics. When generating code for a behavior, behavior orchestration system 502 may consult task catalog 510 to obtain relevant reference code blocks.

Behavior orchestration system 502 may obtain a reference block of machine-executable instructions using a variety of approaches. In some embodiments, behavior orchestration system 502 may employ various search and retrieval methods to obtain relevant records. For example, behavior orchestration system 502 may first analyze a task and/or its associated behavior configuration model to determine a relevant task from task catalog 510, leveraging semantic-based techniques including, but not limited to, Boolean search techniques via TF-IDF scoring, semantic search, keyword search, hybrid retrieval techniques, and cross-encoder re-ranking strategies. Behavior orchestration system 502 may also employ structured searching techniques including, but not limited to, field-specific matching, numerical range queries, faceted search, and fuzzy search. Behavior orchestration system may also leverage LPS 506 and/or language models 508 to analyze one or more tasks retrieved from or stored within task catalog 510 to determine a relevant task, and consequently the corresponding relevant machine-executable instructions. In some embodiments, a self-expanding task catalog may be implemented. In this system, newly generated code blocks that are successfully executed and validated may be added to the task catalog as part of a data pipeline. This may allow the system to learn and expand its capabilities over time, potentially becoming more efficient at generating code for increasingly complex behaviors.

Graph structure 514 may be implemented as a graph database or other suitable graph technology that works in concert with the n-dimensional blockchain structure 512 to provide efficient querying and relationship mapping capabilities. It may include nodes and edges that represent entities, behaviors, relationships, tasks, and blockchain locations and/or coordinates recorded in the n-dimensional blockchain structure 512. Graph structure 514 may allow multi-dimensional relationships to be retrieved without linear traversal of the blockchain structure 512, potentially providing significant performance benefits. Behavior orchestration system 502 may also update graph structure 514 in conjunction with writes to the n-dimensional blockchain structure 512 to maintain a synchronized state. Alternatively or additionally, behavior orchestration system 502 may employ a real-time analytics engine that operates on graph structure 514. This engine could potentially provide insights into the relationships and behaviors within the system, potentially enabling features like anomaly detection, trend analysis, frequency analytics, notch filtering, or predictive modeling based on the data.

In some embodiments, a user or system may submit a query via client device 504 identifying a desired behavior between entities. This query may be transmitted to behavior orchestration system 502, which may then utilize LPS 506 and language models 508 to process the query and generate a behavior configuration model. Behavior orchestration system 502 may consult task catalog 510 to find relevant existing tasks and code blocks that may be reused, adapted, or augemented. Behavior orchestration system 502 may then generate machine-executable instructions for the behavior. During this process, behavior orchestration system 502 may combine existing code blocks from task catalog 510 with newly generated code or simply end up with the newly generated code. Behavior orchestration system 502 may then persist the generated code, along with relevant entity and behavior information, to n-dimensional blockchain structure 512. Behavior orchestration system 502 may also update graph structure 514 to reflect the new relationships and blockchain locations. This process may ensure that all behaviors and their implementations are immutably recorded and efficiently queried.

Alternatively or additionally, a federated learning approach may be implemented, where multiple behavior orchestration systems collaborate to improve their language models and task catalogs while maintaining data privacy. In this scenario, each system may train on its local data and share only model updates or other insights, potentially allowing for collective improvement without exposing sensitive information. By leveraging natural language processing, a catalog of existing tasks, and blockchain/graph technologies, behavior orchestration system architecture 500 may enable efficient creation and execution of complex entity behaviors in a traceable and scalable manner. Behavior orchestration system architecture 500 may represent a significant advancement in behavior orchestration and code generation, particularly in and/or when leveraging blockchain environments and combine the benefits of natural language interfaces, code reuse, blockchain immutability, and graph-based querying to create an efficient and flexible platform for managing complex behaviors and relationships between entities.

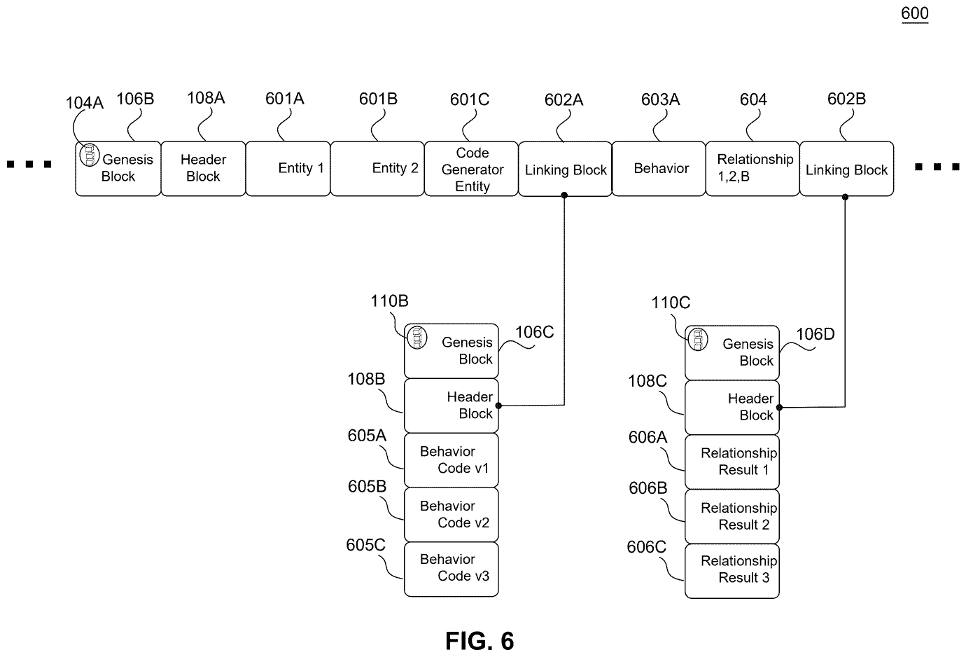

FIG. 6 illustrates linked structure 600 having a first blockchain linked to multiple second blockchains, according to some embodiments. Specifically, FIG. 6 refers to first blockchain 104A and second blockchains 110B and 110C from FIG. 1. However, the use of these chains in particular is merely for ease of illustration, and the characteristics of the chains and implementations discussed below may apply to first blockchains and second blockchains generally, as they relate to various embodiments of the present disclosure. Similar to FIG. 2, first blockchain 104A in FIG. 6 may govern second blockchains 110B and 110C (in FIG. 6), and second blockchains 110B and 110C are subordinate to first blockchain 104A.

In FIG. 6, first blockchain 104A may include genesis block 106B, header block 108A, entity 601A, entity 601B, code generator entity 601C, linking block 602A, behavior 603A, relationship 604, and linking block 204. Second blockchain 110B may include genesis block 106C, header block 108B, and behavior code blocks 605A-605C. Second blockchain 110C may include genesis block 106D, header block 108C, and relationship result blocks 606A-606C.

Similar to FIG. 2, entities 601A and 601B may be written to first blockchain 104A and may represent a human actor, account, object, wallet, token, group, behaviors, combinations of outputs from behaviors, a process, a computer an artificial intelligence construct, an avatar representing an actor or action, an expression or function comprising actions, or any concept of potentially taking action in a behavior. Code generator entity 601C may represent a type of entity responsible for generating machine-executable instructions for behaviors involving one or more entities on a multi-dimensional blockchain structure. In some embodiments, code generator entity 601C may also represent an entity that tracks code that has been generated for a behavior, and any subsequent versions of new code corresponding to that behavior.

Behavior 603A may be written to first blockchain 104A. Behavior 603A may define an action or set of tasks that can be performed between entities. Behavior 603A may correspond to a behavior configuration model that defines discrete tasks, states, and state transitions required to carry out the behavior. In some embodiments, this configuration model may be generated by sending a query describing the desired behavior to a language model. For example, behavior 603A may represent a “secure financial transaction” involving multiple cryptographic verification steps, or a “data sharing agreement” with specified access control and privacy preservation measures.

Relationship 604 may capture the association between specific entities (e.g., entity 1 and entity 2) and behavior 603A. It may represent a codified link between at least one entity and at least one behavior and define how these specific entities interact via the specified behavior. In some embodiments, relationship 604 may include attributes that define the nature of the interaction, such as asset types, values, timing constraints, and/or other relevant parameters for the behavior. For example, in a supply chain scenario, relationship 604 may define the terms of a “product delivery” behavior between a supplier entity and a retailer entity, including details like delivery timeframes, quality standards, and payment terms.

Linking blocks 602A and 602B may link first blockchain 104A to second blockchains 110B and 110C respectively. These linking blocks may contain references and metadata to establish the connections between the blockchains. They may include governance information about the behavior, relationship, and structure of the related blockchains. Linking blocks may also include enforcement mechanisms to perform the tasks comprising the behavior, potentially implemented as smart contracts, append-only structures, blockchain transactions, or journaling protocols.

In the exemplary embodiment depicted by FIG. 6, second blockchain 110B may be dedicated to storing and/or tracking various versions of generated machine-executable instructions for implementing behavior 603A. It may include genesis block 106C, header block 108B, and multiple versions of behavior code (605A, 605B, 605C). Genesis block 106C may serve as the initial block of second blockchain 110B. Header block 108B may follow genesis block 106C and contain metadata about second blockchain 110B, such as references to linking blocks, governance information (e.g., the associated behavior, tasks, structural requirements, etc.), and initialization parameters. Alternatively or additionally, this metadata may be stored in genesis block 106C and/or linking block 602A.

Behavior code blocks 605A-605C may contain different versions of machine-executable instructions for implementing the behavior defined in behavior 603A. Behavior code block 605A may contain behavior code v1, representing an initial version of the code.

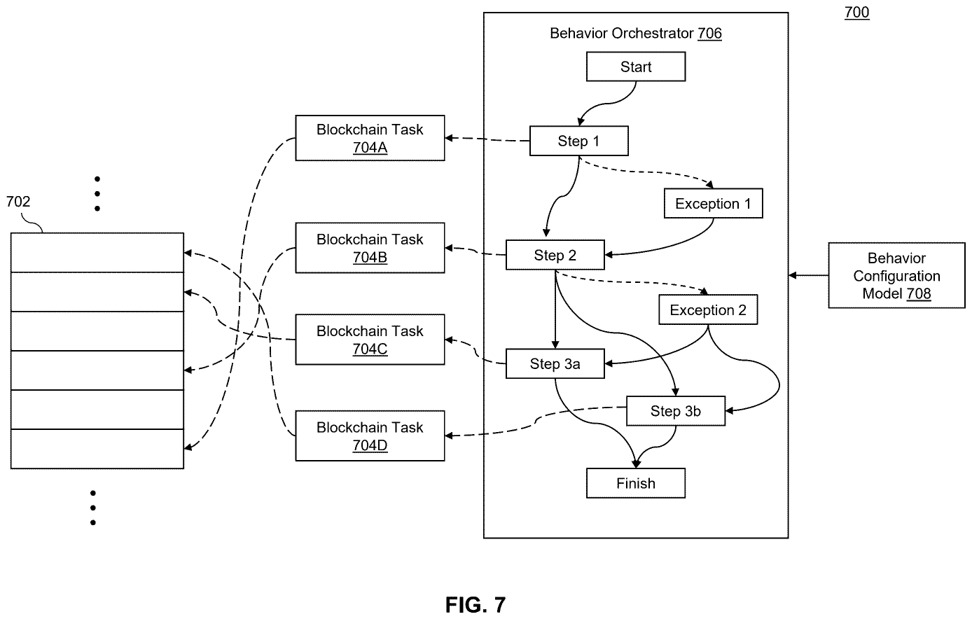

Behavior code block 605B may contain behavior code v2, an updated version. Behavior code block 605C may contain behavior code v3, a further iteration of the code. In some embodiments, behavior code v1, v2, and v3 may be generated by a behavior orchestration system (e.g., behavior orchestration system 502). This versioning approach may enable traceability of code changes over time within the blockchain structure, potentially allowing for iterative refinement and updates to the behavior implementation while maintaining an immutable record of all versions. For example, v1 might represent a basic implementation, v2 could include optimizations for performance, and v3 might incorporate additional security features or compliance requirements. In some embodiments, behavior code blocks 605A-605C may store the actual machine-executable instructions corresponding to the one or more tasks that compose behavior 603A. Alternatively or additionally, behavior code blocks 605A-605C may store one or more references to additional blocks of the N-dimensional blockchain structure containing the machine-executable instructions for the one or more tasks, e.g., task blocks, which will be described in more detail below with respect to FIG. 7.

Second blockchain 110C may be used to record results of executing the behavior between entities (e.g., relationship 604). Second blockchain 110C may include genesis block 106D, header block 108C, and relationship result blocks 606A-606C. Genesis block 106D may serve as the initial block of second blockchain 110C. Header block 108C may contain metadata about the blockchain, initialization parameters, and governance information, including references to linking blocks, the associated behavior, tasks, the associated entities, structural requirements. Alternatively or additionally, this metadata may be stored in genesis block 106D and/or linking block 602B.

Relationship result blocks 606A-606C may record the outcomes of executing different versions of the behavior code with respect to one or more entities. As depicted in FIG. 6, relationship result block 606A may contain relationship result 1, recording the outcome of executing its referenced behavior code on entity 1 and entity 2. For example, relationship result 1 may be the result of executing behavior code v1 written into behavior code block 605A when behavior code v1 was the most recent version. Relationship result block 606B may contain relationship result 2, recording the outcome of executing its referenced behavior code. For example, relationship result 2 may be the result of executing behavior code v1 written into behavior code block 605A, when behavior code v1 was the most recent version. In another example, relationship result 2 may be the result of executing behavior code v2 written into behavior code block 605B, after behavior code v1 is updated with v2. Relationship result block 606C may contain relationship result 3, recording the outcome of executing its referenced behavior code. These result blocks may include inputs, outputs, decisions, variables, and any other components required to complete the tasks that make up the behavior. By recording these results immutably on the blockchain, a complete audit trail may be created and maintained for all executions of the behavior. This may allow for verification and analysis of how the behavior was carried out over time and/or other predictable sequence of operations.

As with the examples described above, examples of specific blockchains, genesis blocks, header blocks, entities, code generator entities, linking blocks, behaviors, relationships, behavior code blocks, and relationship result blocks have been described herein. However, these examples are not meant to be limiting nor meant to represent an exhaustive list of possible implementations. The scope of the technology disclosed herein is not limited to only these examples, and other implementations are contemplated as appreciated by one skilled in the art.

FIG. 7 illustrates an example environment 700 for a linked structure, according to some embodiments. Environment 700 may include a linked structure having a first blockchain 702, blockchain tasks 704A-704D, a behavior orchestrator 706, and a behavior configuration model 708.

In some embodiments, linked structure 702 may represent a first blockchain of N-dimensional blockchain structure that can store various components of the behavior orchestration system. For example, linked structure 702 may include multiple blocks that store code and data related to tasks. In some implementations, these blocks may be referred to as “task blocks” or “blockchain task blocks.” Within linked structure 702, blockchain tasks 704A-704D may be written as discrete blockchain task blocks or sets of blocks into linked structure 702. Each blockchain task block may contain machine-executable instructions corresponding to specific tasks. As depicted in FIG. 7, blockchain tasks 704A-704D may represent individual operations or steps that can be executed as part of a behavior, such as a behavior defined by behavior configuration model 708. Blockchain tasks 704A-704D may represent tasks such as verifying entity credentials, transferring assets between entities, updating state information, or any other atomic operation relevant to the behavior being implemented.

Behavior orchestrator 706 may be responsible for coordinating and managing the execution of tasks defined in the behavior configuration model 708. In some embodiments, behavior orchestrator 706 may include a workflow engine that interprets the behavior configuration model 708 and orchestrates the execution of blockchain tasks 704A-704D accordingly, as a part of a behavior or relationship. The behavior orchestrator 706 may operate by initializing the workflow defined in the behavior configuration model 708, proceeding through a series of steps that correspond to different stages or tasks in the behavior execution. For example, behavior configuration model 708 may be in YAML, TOML, HCL, or XML format. Behavior configuration model 708 may also be plain text or in binary format. At each step, it may invoke the appropriate blockchain task 704A-704D as specified in the configuration model. In some embodiments, behavior configuration model 708 may include exception cases (e.g., exception 1 and exception 2 as depicted in FIG. 7), implementing logic for error handling and alternative execution paths if issues arise during task execution. Behavior orchestrator 706 may also manage parallel execution of tasks, allowing for concurrent processing of independent tasks to improve overall efficiency. Behavior orchestrator 706 may also determine when the entire behavior workflow is complete, likely by checking that all required tasks have been executed successfully or by handling event tasks signifying completed execution tasks according to the behavior configuration model 708.

As a non-limiting example, behavior configuration model 708 may define a behavior for an actor to send another actor an asset. Behavior orchestrator 706 may start at a start node. Then at step 1, behavior orchestrator 706 may leverage code corresponding to blockchain task 704A for verifying a balance of an entity that is giving the asset. If the entity does not have enough balance, behavior orchestrator 706 may proceed to exception 1. Otherwise, behavior orchestrator 706 may proceed to step 2 and verify that an entity that is receiving the asset has an active account. If the entity that is receiving the asset does not have an active account, behavior orchestrator 706 may proceed to exception 2.

In some embodiments, behavior configuration model 708 may define one or more conditionals, for example to proceed to either step 3a corresponding to blockchain task 704C or step 3b corresponding to blockchain task 704D. For example, behavior configuration model 708 may check an attribute of the receiving entity to determine whether to distribute an asset to a single account (e.g., step 3a) or across multiple accounts (e.g., step 3b). Based on the attribute, behavior orchestrator 706 may proceed to either step 3a or step 3b. Behavior orchestrator 706 may then complete the behavior at a finish node. In carrying out each of blockchain tasks 704A-704D, behavior orchestrator 706 (or any other processor(s) responsible for carrying out a behavior defined by behavior configuration model 708) may execute machine-executable instructions written to and/or referenced by the blockchain task blocks corresponding to blockchain tasks 704A-704D on linked structure 702. Each of blockchain tasks 704A-704D may also be stored in a task catalog alongside with or pointing to coordinates for their corresponding machine-executable instructions. Code for blockchain tasks 704A-704D may also have been generated specifically for a particular behavior (e.g., a behavior defined by behavior configuration model 708). When executed, blockchain tasks 704A-704D may interact with a multi-dimensional blockchain structure to read or write data relevant to their operations, including querying entity information, recording transaction details, or updating relationship states within the blockchain structure.

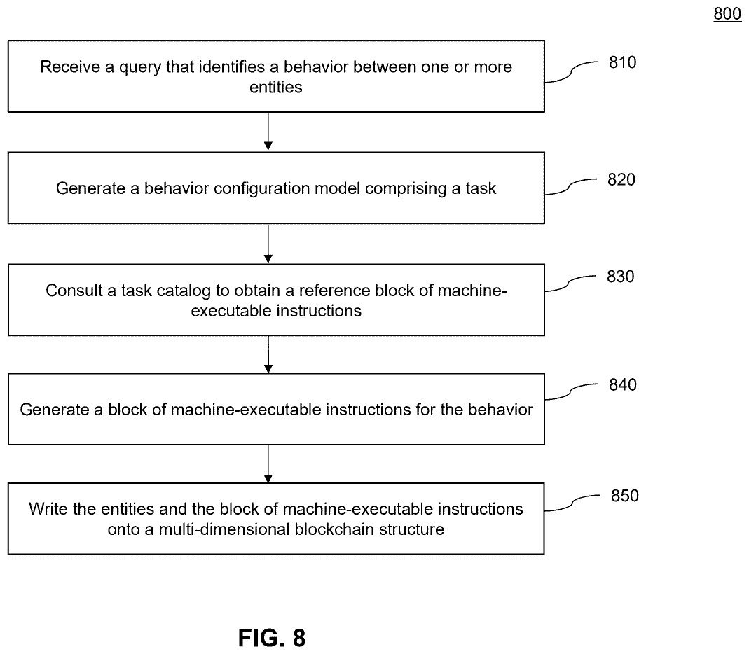

FIG. 8 illustrates an example flow diagram 800 for generating and recording machine-executable instructions that can be carried out in line with the discussion above, according to some embodiments. Method 800 can be performed by processing logic that may comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 8, as will be understood by a person of ordinary skill in the art. Further, method 800 may not include all the steps illustrated.

Method 800 shall be described with reference to FIGS. 1-7. However, method 800 is not limited to those example embodiments. One or more of the operations in the method depicted by FIG. 8 may be carried out by one or more entities, including, without limitation, behavior orchestration system 502, client device 504, LPS 506, behavior orchestrator 706, other server or cloud-based server processing systems and/or one or more entities operating on behalf of or in cooperation with these or other systems. One or more of the operations in the method depicted by FIG. 8 may also or instead be carried out by one or more servers of an enterprise network and/or a cloud computing network and accessed via a client computer system that is connected thereto. Any such system may embody a computing system, such as a programmed processing unit or the like, configured to carry out one or more of the method operations. Further, a non-transitory data storage (e.g., disc storage, flash storage, or other computer readable medium) may have stored thereon instructions executable by a processing unit to carry out the various depicted operations.

In 810, a query that identifies a behavior between one or more entities is received. For example, behavior orchestration system 502 may receive user query 522 from client device 504 describing a behavior or use case. User query 522 may identify one or more entities. User query 522 may specify a desired behavior to be performed between one or more entities on n-dimensional blockchain structure 512 and/or request generated code for the behavior. User query 522 may be in natural language format and describe the behavior at a high level. For example, user query 522 could be “create a behavior for transferring funds between two accounts” or “generate code for a voting mechanism between multiple entities.” User query 522 may identify the general behavior (e.g., transferring funds, voting) as well as the entities involved (e.g., two accounts, multiple entities).

In some embodiments, user query 522 may include additional parameters or constraints for the behavior in some embodiments. For example, the query might specify “create a behavior for transferring funds between two accounts with a daily transfer limit of $1000” or “generate code for a voting mechanism between multiple entities with a 48-hour voting window.” These additional parameters may be used to further refine a behavior configuration model, any tasks for an identified behavior, and/or the resulting generated code. In some embodiments, behavior orchestration system 502 may parse and process the user query 522 to extract information about the desired behavior and entities using any natural language processing techniques, such as named entity recognition and intent classification.

In 820, a behavior configuration model comprising a task is generated. For example, behavior orchestration system 502 may send user query 522 to one of language models 508 of LPS 506 to generate a behavior configuration model. In some embodiments, behavior orchestration system 502 may format user query 522 into a prompt and/or use a prompt template to formulate a prompt. In some embodiments, language models 508 and/or LPS 506 may also reference a context for a multi-dimensional blockchain structure. This context may include information about existing entities, behaviors, relationships, and tasks recorded on the multi-dimensional blockchain structure. In some embodiments, this information may be included within a prompt directly, for example as one-shot examples or few-shot examples. Using this context and the formulated query (e.g., directly received from client device 504 as user query 522 or with some processing using prompt(s) and/or prompt templates stored on behavior orchestration system 502), language models 508 may generate a behavior configuration model that may include at least one task needed to accomplish the specified behavior.

In some embodiments, the generated behavior configuration model may be a structured representation, such as a finite automaton or state machine, that defines the discrete tasks and their relationships needed to perform the behavior. Each task in the model may correspond to a state or node, with transitions between tasks representing the flow of information, data, or logic within the behavior. The behavior configuration model may also specify inputs, outputs, and transition conditions for each task. In some embodiments, the generated behavior configuration model may include conditional logic or branching paths to handle different scenarios. For instance, in a voting behavior, the model might include separate paths for scenarios where the vote passes or fails. This may allow for more complex and flexible behaviors to be modeled and implemented.

In 830, a reference block of machine-executable instructions is obtained by consulting a task catalog. For example, behavior orchestration system 502 may consult task catalog 510 using a task identified in the generated behavior configuration model to obtain a reference block of machine-executable instructions corresponding to that task. In some embodiments, task catalog 510 may contain pre-defined tasks and their corresponding machine-executable instructions that have been previously generated and verified. This may allow the system to leverage existing, working code for inferable tasks (or subtasks) rather than re-generating or re-creating code each time. By referencing the task catalog 510, the behavior orchestration system 502 may identify and obtain relevant and verified code blocks to use as a starting point or reference for generating the final block of machine-executable instructions for the specified behavior.

Behavior orchestration system 502 may obtain a reference block of machine-executable instructions using a variety of approaches. In some embodiments, behavior orchestration system 502 may employ various search and retrieval methods to obtain relevant records. For example, behavior orchestration system 502 may first analyze a task and/or its associated behavior configuration model to determine a relevant task from task catalog 510, leveraging semantic-based techniques including, but not limited to, Boolean search techniques via TF-IDF scoring, semantic search, keyword search, hybrid retrieval techniques, and cross-encoder re-ranking strategies. Behavior orchestration system 502 may also employ structured searching techniques including, but not limited to, field-specific matching, numerical range queries, faceted search, and fuzzy search. Behavior orchestration system may also leverage LPS 506 and/or language models 508 to analyze one or more tasks retrieved from or stored within task catalog 510 to determine a relevant task, and consequently the corresponding relevant machine-executable instructions.

In 840, a block of machine-executable instructions for the behavior is generated. For example, behavior orchestration system 502 may generate a block of machine-executable instructions for the behavior identified in the query received in 810. In some embodiments, behavior orchestration system 502 may generate a block of machine-executable instructions for the identified task associated with the behavior from the behavior configuration model. The generation may be performed by language processing system 506 using one or more language models 508.

The generated behavior configuration model may provide a structured representation of the behavior and its necessary tasks. The generated behavior configuration model and may serve as a blueprint for generating the actual code in a more controlled and fine-tuned manner. The reference block of machine-executable instructions obtained from the task catalog in may also provide additional context and/or serve as a starting point or template for generating the block of machine-executable instructions. In some embodiments, LPS 506 may analyze the behavior configuration model to determine the overall structure and flow of the behavior, for example via natural language processing techniques. It may then leverage the reference block of machine-executable instructions and the determined structure as a basis for generating the final piece of code. This process may involve techniques such as code templating, where sections of the reference code are parameterized and filled in with specific values from the configuration model. In some embodiments, behavior orchestration system 502 may also generate test cases along with the code, based on the behavior configuration model. These test cases can be used to verify the correctness of the generated code before it is written to the n-dimensional blockchain. These test results may themselves be written to another first or second blockchain as records of the code behavior as the software changes over time.

In some embodiments, the behavior configuration model may have multiple tasks. In such embodiments, behavior orchestration system 502 may generate additional blocks of machine-executable instructions for the behavior and the one or more additional tasks. In some embodiments, behavior orchestration system 502 may consult task catalog 510 using one or more additional tasks but not obtain a reference task or a reference block of machine-executable instructions. For example, a task may be too dissimilar to the tasks stored in task catalog 510 (e.g., a similarity between an input task and the tasks in task catalog 510 is below a threshold). In such embodiments, behavior orchestration system 502 may generate a corresponding block of machine-executable instructions without a reference block (e.g., only using the behavior configuration model). In some embodiments, any queries to generate subsequent blocks of machine-executable instructions may include any code that has already been generated as context.

In 850, the one or more entities and the block of machine-executable instructions are written onto the multi-dimensional blockchain structure. For example, behavior orchestration system 502 may write one or more entities (e.g., entity 601A, entity 601B, and code generator entity 601C) and the generated block of machine-executable instructions for the behavior (e.g., behavior code blocks 605A-605C) onto N-dimensional blockchain structure 512. In some embodiments, the entities may be written to a first blockchain (e.g., first blockchain 104A) of N-dimensional blockchain structure 512. The block of machine-executable instructions may be written to a second blockchain (e.g., second blockchain 110B) that is linked to the first blockchain. For example, linking block 602A on first blockchain 104A may link to header block 108B of second blockchain 110B. In some embodiments, the task and the generated block of machine-executable instructions may be inserted into task catalog 510. In some embodiments, behavior orchestration system 502 may execute the generated block of machine-executable instructions and record any results of the generated block of machine-executable instructions in a second blockchain (e.g., second blockchain 110C).

In embodiments where multiple blocks of machine-executable instructions are generated for multiple tasks, the multiple blocks of machine-executable instructions may be treated as one aggregate block including multiple modular machine-executable instructions, which may be referred to as a block of machine-executable instructions for the whole behavior. Any additional modular machine-executable instructions generated for tasks may also be inserted into task catalog 510.

Writing the entities and behavior code onto N-dimensional blockchain structure 512 may provide several technical benefits, including immutability, traceability, access control, and version control of the generated code. Each version of the behavior code (e.g., behavior code v1 605A, v2 605B, v3 605C) may be appended as a new block to second blockchain 110B, creating an auditable history of code updates. This blockchain-based approach may allow for efficient retrieval of specific code versions and provide a tamperproof record of code updates over time. In some embodiments, the system may also write metadata about the code generation process to the blockchain (e.g., inside a code generator entity block, a linking block, a behavior block, or a header block for a second blockchain). The metadata may include the original query (and/or information about the original query), the generated behavior configuration model, and any optimizations or design decisions made during code generation. This metadata may provide valuable context for subsequent analysis or future updates to the behavior.

In some embodiments, the entities, behaviors, relationships, and/or blocks of machine-executable instructions written to the blockchain may be reflected as nodes and edges in a graph (or graph data store) corresponding to N-dimensional blockchain structure 512 (e.g., graph structure 514). This may allow for efficient, relationship-based querying of the behavior code and associated entities. This hybrid blockchain-graph approach provides an immutable system with efficient relationship traversal capabilities. Alternatively or additionally, behavior orchestration system 502 may implement a hybrid on-chain/off-chain approach. In such embodiments, the behavior code may be stored off-chain (e.g., in a distributed file system), with only a hash of the code and metadata stored on the blockchain. This approach may help manage blockchain storage costs and resource usage while still maintaining the benefits of blockchain-based version control and auditing.

FIG. 9 depicts an example computer system useful for implementing various embodiments described herein.

Various embodiments may be implemented, for example, using one or more well-known computer systems, such as computer system 900 shown in FIG. 9. One or more computer systems 900 may be used, for example, to implement any of the aspects discussed herein, as well as combinations and sub-combinations thereof. For example, the example computer system may be implemented as part of behavior orchestration system 502, client device 504, LPS 106, etc. Cloud implementations may include one or more of the example computer systems operating locally or distributed across one or more server sites.

Computer system 900 may include one or more processors (also called central processing units, or CPUs), such as a processor 904. Processor 904 may be connected to a communication infrastructure or bus 906.

Computer system 900 may also include customer input/output device(s) 902, such as monitors, keyboards, pointing devices, etc., which may communicate with communication infrastructure 906 through customer input/output interface(s) 902.

One or more of processors 904 may be a graphics processing unit (GPU). In an aspect, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 900 may also include a main or primary memory 908, such as random access memory (RAM). Main memory 908 may include one or more levels of cache. Main memory 908 may have stored therein control logic (i.e., computer software) and/or data.

Computer system 900 may also include one or more secondary storage devices or memory 910. Secondary memory 910 may include, for example, a hard disk drive 912 and/or a removable storage device or drive 914. Removable storage drive 914 may be a floppy disk drive, a magnetic tape drive, a compact disk drive, an optical storage device, tape backup device, and/or any other storage device/drive.

Removable storage drive 914 may interact with a removable storage unit 916. Removable storage unit 916 may include a computer usable or readable storage device having stored thereon computer software (control logic) and/or data. Removable storage unit 916 may be a floppy disk, magnetic tape, compact disk, DVD, optical storage disk, and/any other computer data storage device. Removable storage drive 914 may read from and/or write to removable storage unit 916.

Secondary memory 910 may include other means, devices, components, instrumentalities or other approaches for allowing computer programs and/or other instructions and/or data to be accessed by computer system 900. Such means, devices, components, instrumentalities or other approaches may include, for example, a removable storage unit 922 and an interface 920. Examples of the removable storage unit 922 and the interface 920 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 900 may further include a communication or network interface 924. Communication interface 924 may enable computer system 900 to communicate and interact with any combination of external devices, external networks, external entities, etc. (individually and collectively referenced by reference number 928). For example, communication interface 924 may allow computer system 900 to communicate with external or remote devices 928 over communications path 926, which may be wired and/or wireless (or a combination thereof), and which may include any combination of LANs, WANs, the Internet, etc. Control logic and/or data may be transmitted to and from computer system 900 via communication path 926.

Computer system 900 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 900 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (Saas), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 900 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML Customer Interface Language (XUL), or any other functionally similar representations alone or in combination. Alternatively, proprietary data structures, formats or schemas may be used, either exclusively or in combination with known or open standards.

In some aspects, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 900, main memory 908, secondary memory 910, and removable storage units 916 and 922, as well as tangible articles of manufacture embodying any combination of the foregoing. Such control logic, when executed by one or more data processing devices (such as computer system 900), may cause such data processing devices to operate as described herein.

Based on the teachings contained in this disclosure, it will be apparent to persons skilled in the relevant art(s) how to make and use aspects of this disclosure using data processing devices, computer systems and/or computer architectures other than that shown in FIG. 9. In particular, aspects can operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more but not all exemplary aspects of the present disclosure as contemplated by the inventor(s), and thus, are not intended to limit the present disclosure and the appended claims in any way.

Aspects of the present disclosure have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific aspects will so fully reveal the general nature of the disclosure that others can, by applying knowledge within the skill of the art, readily modify and/or adapt for various applications such specific aspects, without undue experimentation, without departing from the general concept of the present disclosure. Therefore, such adaptations and modifications are intended to be within the meaning and range of equivalents of the disclosed aspects, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

It is to be appreciated that the Detailed Description section, and not the Summary and Abstract sections, is intended to be used to interpret the claims. The Summary and Abstract sections may set forth one or more but not all exemplary aspects of the present disclosure as contemplated by the inventor(s), and thus, are not intended to limit the present disclosure and the appended claims in any way.

The breadth and scope of the present disclosure should not be limited by any of the above-described exemplary aspects, but should be defined only in accordance with the following claims and their equivalents.

1. A computer-implemented method, comprising:
receiving, by one or more processors, a query that identifies a behavior between one or more entities;
generating a behavior configuration model comprising at least two tasks and a transition condition between the at least two tasks by sending the query to a language model that references a context for a multi-dimensional blockchain structure, wherein the context comprises a plurality of relationships and a plurality of entities recorded on the multi-dimensional blockchain structure;
consulting a task catalog using at least one task of the at least two tasks to obtain a first reference block of machine-executable instructions corresponding to the at least one task within the task catalog and a second reference block of machine-executable instructions corresponding to the transition condition;
generating a block of machine-executable instructions for the behavior based on the behavior configuration model, the first reference block of machine-executable instructions, and the second reference block of machine-executable instructions; and
in response to the generating, writing the one or more entities and the block of machine-executable instructions for the behavior onto the multi-dimensional blockchain structure.

2. The computer-implemented method of claim 1, further comprising:
building the task catalog by examining a pre-defined task of a pre-defined behavior recorded on the multi-dimensional blockchain structure and a pre-defined block of machine-executable instructions corresponding to the pre-defined task.

3. The computer-implemented method of claim 1, further comprising:
generating, using the language model, a second block of machine-executable instructions corresponding to a second task of the behavior configuration model, wherein a corresponding reference block of machine-executable instructions for the second task does not exist within the task catalog.

4. The computer-implemented method of claim 3, wherein the generating the block of machine-executable instructions for the behavior is further based on the second block of machine-executable instructions corresponding to the second task.

5. The computer-implemented method of claim 3, further comprising:
inserting the second task and the second block of machine-executable instructions corresponding to the second task into the task catalog.

6. The computer-implemented method of claim 1, further comprising:
executing the block of machine-executable instructions to perform the behavior between the one or more entities; and
recording a result of the behavior in a blockchain of the multi-dimensional blockchain structure.

7. The computer-implemented method of claim 1, further comprising:
recording the one or more entities and the block of machine-executable instructions for the behavior in a graph data store, wherein one or more resulting nodes in the graph data store correspondingly represent the one or more entities and a second node in the graph data store represents the behavior.

8. The computer-implemented method of claim 7, further comprising:
constructing a graph query to retrieve the block of machine-executable instructions for the behavior involving the one or more entities; and
executing the graph query against the graph data store to retrieve the block of machine-executable instructions for the behavior.

9. The computer-implemented method of claim 1, wherein the behavior configuration model defines governance information of the one or more entities.

10. The computer-implemented method of claim 1, wherein the context for the multi-dimensional blockchain structure comprises one or more few-shot examples of pre-defined behavior configuration models.

11. A system comprising:
a memory;
at least one processor coupled to the memory and configured to:
receive a query that identifies a behavior between one or more entities;
generate a behavior configuration model comprising at least two tasks and a transition condition between the at least two tasks by sending the query to a language model that references a context for a multi-dimensional blockchain structure, wherein the context comprises a plurality of relationships and a plurality of entities recorded on the multi-dimensional blockchain structure;
consult a task catalog using at least one of the at least two tasks to obtain a first reference block of machine-executable instructions corresponding to the at least one task within the task catalog and a second reference block of machine-executable instructions corresponding to the transition condition;
generate a block of machine-executable instructions for the behavior based on the behavior configuration model, the first reference block of machine-executable instructions, and the second reference block of machine-executable instructions; and
in response to generating the block of machine-executable instructions, write the one or more entities and the block of machine-executable instructions for the behavior onto the multi-dimensional blockchain structure.

12. The system of claim 11, the at least one processor further configured to:
build the task catalog by examining a pre-defined task of a pre-defined behavior recorded on the multi-dimensional blockchain structure and a pre-defined block of machine-executable instructions corresponding to the pre-defined task.

13. The system of claim 11, the at least one processor further configured to:
generate, using the language model, a second block of machine-executable instructions corresponding to a second task of the behavior configuration model, wherein a corresponding reference block of machine-executable instructions for the second task does not exist within the task catalog.

14. The system of claim 13, wherein to generate the block of machine-executable instructions for the behavior, the at least one processor is further configured to:
generate the block of machine-executable instructions for the behavior based on the second block of machine-executable instructions corresponding to the second task.

15. The system of claim 13, the at least one processor further configured to:
insert the second task and the second block of machine-executable instructions corresponding to the second task into the task catalog.

16. The system of claim 11, the at least one processor further configured to:
execute the block of machine-executable instructions to perform the behavior between the one or more entities; and
record a result of the behavior in a blockchain of the multi-dimensional blockchain structure.

17. The system of claim 11, the at least one processor further configured to:
record the one or more entities and the block of machine-executable instructions for the behavior in a graph data store, wherein one or more resulting nodes in the graph data store correspondingly represent the one or more entities, and a second node in the graph data store represents the behavior.

18. A non-transitory computer-readable medium having instructions stored thereon that, when executed by at least one computing device, causes the at least one computing device to perform operations comprising:
receiving a query that identifies a behavior between one or more entities;
generating a behavior configuration model comprising at least two tasks and a transition condition between the at least two tasks by sending the query to a language model that references a context for a multi-dimensional blockchain structure, wherein the context comprises a plurality of relationships and a plurality of entities recorded on the multi-dimensional blockchain structure;
consulting a task catalog using at least one task of the at least two tasks to obtain a first reference block of machine-executable instructions corresponding to the at least one task within the task catalog and a second reference block of machine-executable instructions corresponding to the transition condition;
generating a block of machine-executable instructions for the behavior based on the behavior configuration model, the first reference block of machine-executable instructions, and the second reference block of machine-executable instructions; and
in response to the generating, writing the one or more entities and the block of machine-executable instructions for the behavior onto the multi-dimensional blockchain structure.

19. The non-transitory computer-readable medium of claim 18, the operations further comprising:
building the task catalog by examining a pre-defined task of a pre-defined behavior recorded on the multi-dimensional blockchain structure and a pre-defined block of machine-executable instructions corresponding to the pre-defined task.

20. The non-transitory computer-readable medium of claim 18, the operations further comprising:
generating, using the language model, a second block of machine-executable instructions corresponding to a second task of the behavior configuration model, wherein a corresponding reference block of machine-executable instructions for the second task does not exist within the task catalog.
